(19) United States
(12) Patent Application Publication
(10) Pub. No.: US 2008/0233896 A1
(43) Pub. Date: Sep. 25, 2008

(54) FLOATING CABLE-FED INFORMATION TRANSCEIVER APPARATUS

(76) Inventor: Yuejun YAN, Shenzhen (CN)

Correspondence Address: MATTHIAS SCHOLL, 14781 MEMORIAL DRIVE, SUITE 1319, HOUSTON, TX, 77079, US

(21) Appl. No.: 11/848,218

(22) Filed: Aug. 30, 2007

Related U.S. Application Data
(63) Continuation-in-part of application No. PCT/CN2007/000937, filed on Mar. 22, 2007.

(51) Int. Cl. H04B 1/38

(52) U.S. Cl. 455/90.3

(57) ABSTRACT

Taught herein is a floating cable-fed information transceiver apparatus comprising a suspended object, an information transceiving device, a carrier, a power supply and a power cable line. The information transceiving device is connected to the suspended object. The power supply is disposed inside the carrier. One end of the power cable line is connected to the information transceiving device, and the other end thereof is connected to the power supply on the carrier and serves to supply power to the information transceiving device.

### CROSS-REFERENCE TO RELATED APPLICATION

This application is a continuation-in-part of International Patent Application No. PCT/CN2007/000937 with an international filing date of Mar. 22, 2007, the contents of which are incorporated herein by reference.

### BACKGROUND OF THE INVENTION

### Field of the Invention

The invention relates generally to an information transceiver apparatus, and more particularly to a floating cable-fed information transceiver apparatus.

Communication towers anchored to the ground or attached to mobile carriers are generally used to implement long-range transmission and wide area coverage in the fields of communication, navigation and positioning, sensing, optics and infrared imaging. They allow detecting, receiving, and relaying various types of information and signals.

However, since the height of communication towers is limited their coverage area is correspondingly limited. In addition, performance agility and flexibility of the communication towers is relatively poor. Although planes, balloons and zeppelins have been employed as substitute of communication towers, their high cost, large size, low robustness, and the need for high-frequency of refueling makes them impracticable for many applications.

Accordingly much opportunity for improvement remains in this area of technology.

### SUMMARY OF THE INVENTION

In one embodiment provided is a floating cable-fed information transceiver apparatus, comprising: a suspended object; an information transceiving device connected to the suspended object; a carrier; a power supply arranged inside the carrier; and a power cable line having a first end and a second end; wherein the first end of the power cable line is connected to the information transceiving device, and the second end is connected to the power supply.

In certain embodiments, the suspended object is a balloon, an zeppelin, a suspended object with a propeller, a suspended object with a propeller and a rudder, or a combination thereof.

In certain embodiments, the suspended object is connected to the power supply via the power cable line.

In certain embodiments, the information transceiving device transmits and/or receives information.

In certain embodiments, the information transceiving device transmits and receives a radio signal, an optical signal or an infrared signal.

In certain embodiments, the floating cable-fed information transceiver apparatus further comprises an information processing terminal having one of its ends connected to the information transceiving device.

In certain embodiments, the information processing terminal is disposed inside the carrier.

In certain embodiments, the information processing terminal is disposed outside the carrier.

In certain embodiments, the information transceiving device is disposed inside the suspended object.

In certain embodiments, the information transceiving device is disposed outside the suspended object.

In certain embodiments, the suspended object is connected to the carrier via one or more fixed lines.

In certain embodiments, the suspended object is a balloon or a zeppelin, a gas pipe is disposed between the carrier and the suspended object.

In certain embodiments, the floating cable-fed information transceiver apparatus further comprises an altitude sensor and an altitude controller being connected with the suspended object or the information transceiving device.

In certain embodiments, the floating cable-fed information transceiver apparatus further comprises a navigation and positioning device being connected with the suspended object or the information transceiving device.

In certain embodiments, the information transceiving device comprises a control rudder.

To reduce the size and the weight of the information transceiving device, the information transceiving device may be simply a front end with an antenna, an up-converter and a down-converter. In case that a loss of a carrier frequency signal is low, only an antenna, a filter, a low-noise amplifier and a power amplifier are needed. At this time, a back end is installed on a carrier on the ground or water surface, and is connected to the information transceiving device via fiber optics. The information transceiving device may also be a complete transceiver.

Energy may be provided from the ground or the water surface, so as to reduce a size, cost and weight of the suspended object and the information transceiving device.

From a broader view, a sensor may be installed on the information transceiving device for irregularly detecting a flying direction and a flying angle, and for avoiding crash.

Compared with the prior art, advantages of the invention comprises:
a. Providing sufficient power via power cables, and suitable for relay detecting devices that stays in the air for a long time, and for high power coverage;
b. Suitable for long-distance and wide-area coverage since a height of the suspended object may be adjusted (up to thousands of meters) as required;
c. Not limited by a traditional concept of an airballoon or an airship, the invention may be a suspended object of a helicopter airscrew with power cables, which reduces an overall size, and makes it difficult for an enemy to detect, and improves flexibility and invisibility;
d. Low cost, and may reproduce substantially in short time;
e. The information transceiving device is capable of exchanging information with remote relays wirelessly, and a communication network may be established by a plurality of systems of the invention;
f. Assisting in searching and saving a ground or water object.
g. Weather monitoring;
h. Broadcasting of television relay

### BRIEF DESCRIPTION OF THE DRAWINGS

Other advantages and novel features of the invention will become more apparent from the following detailed description when taken in conjunction with the accompanying drawings, in which:

FIG. 1 is a structural diagram of a floating cable-fed information transceiver apparatus in accordance with one embodiment of the invention;

FIG. 2 is a structural diagram thereof with an information processing terminal arranged inside a carrier;

FIG. 3 is a structural diagram thereof illustrating a local area network formed of a plurality of information processing terminals arranged outside the carrier;

FIG. 4 is a structural diagram thereof illustrating position fixing of a suspended object;

FIG. 5 is a structural diagram thereof illustrating an information transceiving device operating as an optical or infrared camera;

FIG. 6 is a structural diagram thereof employing an altitude sensor and an altitude controller;

FIG. 7 is a structural diagram thereof employing a navigation and positioning device; and

FIG. 8 is a structural diagram thereof as utilized in radio detection and ranging.

### DETAILED DESCRIPTION OF THE INVENTION

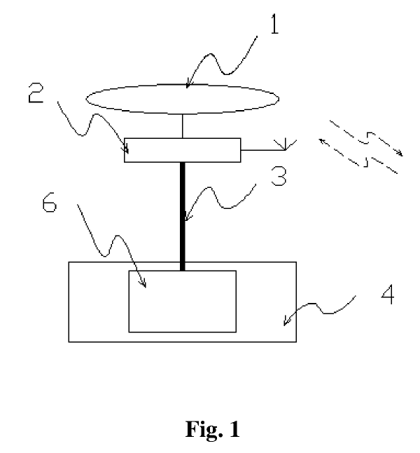

FIG. 1 is a structural diagram of a floating cable-fed information transceiver apparatus of an exemplary embodiment of the invention. The floating cable-fed information transceiver apparatus comprises a suspended object 1, an information transceiving device 2, a power cable line 3, a carrier 4 and a power supply 6. The suspended object is a balloon, a zeppelin, a suspended object with a propeller, a suspended object with a propeller and a rudder, or a combination thereof. A rudder (not shown) is installed on the suspended object 1 for adjusting directions of movement. A direction sensor (not shown) is also installed on the suspended object 1 for testing and changing directions of movement.

The information transceiving device 2 is arranged inside the suspended object 1 for receiving and transmitting information from and to the outside. Directions of transmitting or receiving information may be fixed or adjusted by the direction sensor and/or the rudder on the suspended object 1, or by the carrier 4. It should be noted that in other embodiments, the information transceiving device 2 may be arranged outside the suspended object 1, and the direction sensor and the rudder may be directly installed on the information transceiving device 2.

The power cable line 3 connects the information transceiving device 2 to the power supply 6.

The carrier 4 is a terrestrial carrier, such as an automotive, or an aquatic carrier, such as a ship.

The information transceiving device 2 is connected to the power supply 6 via the power cable line 3 for supplying power thereto. If the suspended object 1 needs power, the power supply 6 may supply power thereto.

The suspended object 1 moves synchronously with the carrier. For example, the suspended object 1 may be made as a helicopter-like flying object that is powered by electricity instead of fuel, controlled by a carrier on the ground or water surface, moves along with a motive carrier, and freely sets a height and a direction of the information transceiving device.

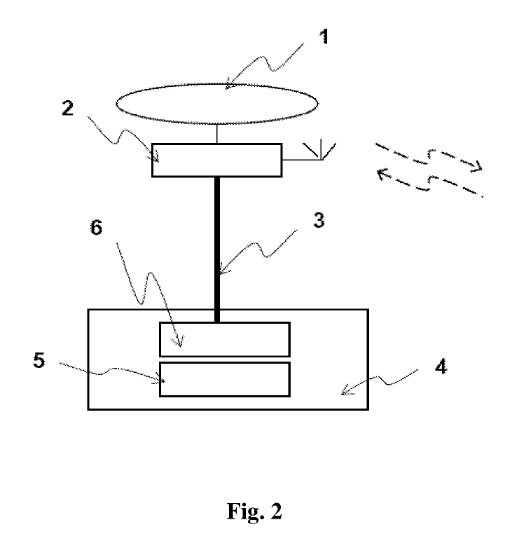

FIG. 2 is illustrates information processing terminal 5 arranged inside the carrier 4. The information processing terminal 5 exchanges information with the information transceiving device 2 via an optical cable, an electric cable, or wireless communication. In certain embodiments, the information processing terminal 5 is disposed inside a car.

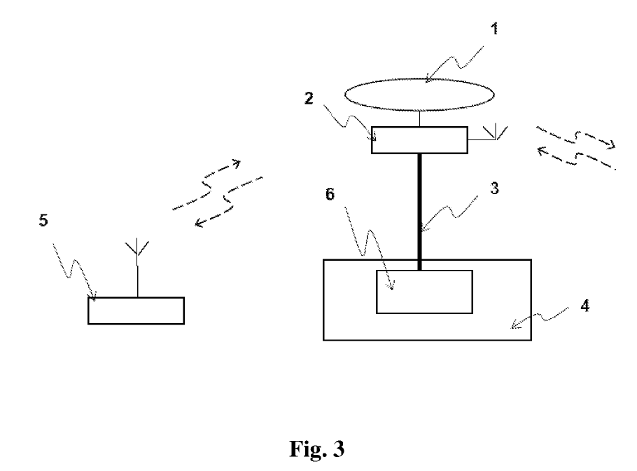

FIG. 3 is a diagram illustrating a local area network formed of a plurality of information processing terminals 5 arranged outside the carrier 4. In this embodiment, a plurality of information transceiving terminals 5 outside the carrier 4 forms multiple local area networks, which communicate with each other in a wireless or a wired manner.

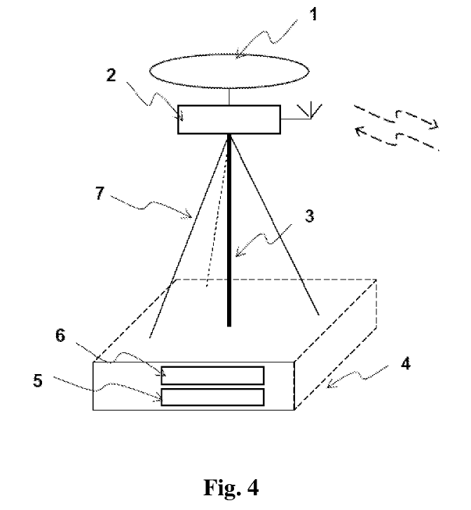

FIG. 4 is a diagram illustrating positional fixing of the suspended object 1. As shown in FIG. 4, to prevent the suspended object 1 from drifting with airflow or wind, one or more cords 7 are connected between the information transceiving device 2 and the carrier 4. In this embodiment, three triangularly distributed cords are employed to fix and adjust the position of the suspended object 1 and the information transceiving device 2 with respect to the carrier 4.

To avoid air crash, a warning lamp or a radio warning device may be installed on the suspended object 1.

If the suspended object 1 is a balloon or a zeppelin, an energy source, such as a gas source is disposed on the carrier 4 to supply, e.g., gas to the suspended object 1. In this way, the height of the suspended object 1 may be adjusted. In this embodiment, the shape of the suspended object 1 is chosen to be circular, elliptical or oblate, so as to easily change directions and to decrease the wind resistance.

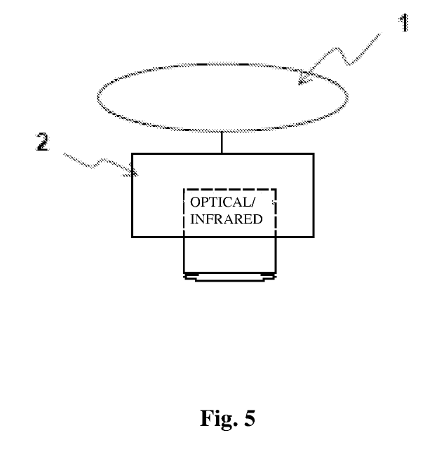

FIG. 5 is a diagram illustrating the information transceiving device 2 operating as an optical or infrared camera.

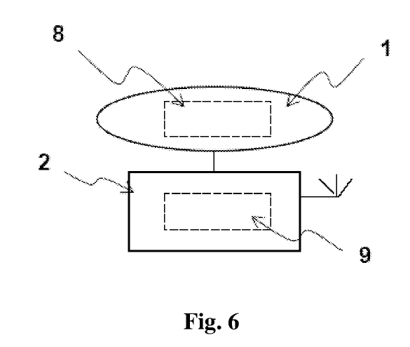

FIG. 6 is a diagram illustrating a floating cable-fed information transceiver apparatus employing an altitude sensor 8 and an altitude controller 9. The altitude sensor 8 and the altitude controller 9 are arranged inside the suspended object 1 and the information transceiving device 2, respectively, and allow for controlling and adjusting altitudes, locations and directions of the suspended object 1.

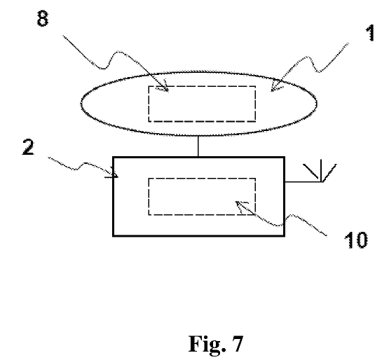

FIG. 7 is a diagram illustrating a floating cable-fed information transceiver apparatus employing a navigation and positioning device 10. The navigation and positioning device 10 is arranged inside the information transceiving device 2. The altitude sensor 8 and the altitude controller 9 employs the navigation and positioning device 10 to determine, control and adjust positions, locations and altitudes of the suspended object 1.

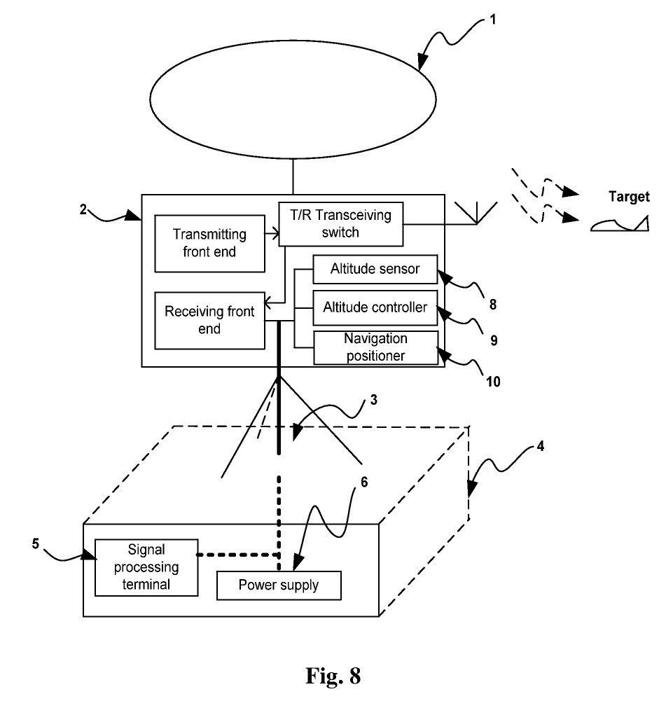

FIG. 8 illustrates a floating cable-fed information transceiver apparatus as utilized in radio detection and ranging. The main components of the radar are arranged within the floating cable-fed information transceiver apparatus. Specifically, a radar transceiver (not shown) is disposed in the suspended object 1. A transceiving switch, a receiving front end, and a transmitting front end are arranged in the information transceiving device 2. A power amplifier and a low noise amplifier (not shown) are also arranged on the information transceiving device 2. In this embodiment, the information processing terminal 5 and the power supply are arranged on the carrier 4.

The suspended object 1 and the information transceiving device 2 cooperate with the altitude sensor 8 and the altitude controller 9 to control altitudes, locations and directions of the suspended object 1, and thus to perform control of the signal transceiving direction.

In addition, the suspended object 1 and the information transceiving device 2 may cooperate with the navigation and positioning device 10, to determine, control and adjust positions, locations and altitudes of the suspended object 1. It should be noted further that in other embodiments, a control rudder is directly installed on the information transceiving device 2 and assists in changing directions of receiving/transmitting information.

In another embodiment, a propeller-like device or a direction rudder is installed on the suspended object 1 and/or the information transceiving device 2. The propeller-like device or the direction rudder make use of information provided by the navigation and positioning device 10 to adjust positions, locations and altitudes of the suspended object 1 and the information transceiving device 2.

It is believed that the present embodiments and their advantages will be understood from the foregoing description, and it will be apparent that various changes may be made thereto without departing from the spirit and scope of the invention or sacrificing all of its material advantages, the examples hereinbefore-described merely being preferred or exemplary embodiments.

What is claimed is:

1. A floating cable-fed information transceiver apparatus, comprising:
a suspended object;
an information transceiving device connected to said suspended object;
a carrier;
a power supply arranged inside said carrier; and
a power cable line having a first end and a second end; wherein
said first end of the power cable line is connected to said information transceiving device, and said second end is connected to said power supply.

2. The apparatus of claim 1, wherein said suspended object is a balloon, an zeppelin, a suspended object with a propeller, a suspended object with a propeller and a rudder, or a combination thereof.

3. The apparatus of claim 2, wherein said suspended object is connected to said power supply via said power cable line.

4. The apparatus of claim 1, wherein said information transceiving device transmits and/or receives information.

5. The apparatus of claim 4, wherein said information transceiving device transmits and receives a radio signal, an optical signal or an infrared signal.

6. The apparatus of claim 1, further comprising an information processing terminal having one of its ends connected to said information transceiving device.

7. The apparatus in of claim 6, wherein said information processing terminal is disposed inside said carrier.

8. The apparatus of claim 6, wherein said information processing terminal is disposed outside said carrier.

9. The apparatus of claim 6, wherein said information transceiving device is disposed inside said suspended object.

10. The apparatus of claim 6, wherein said information transceiving device is disposed outside said suspended object.

11. The apparatus of claim 10, wherein said suspended object is connected to said carrier via one or more fixed lines.

12. The apparatus of claim 2, wherein when said suspended object is a balloon or a zeppelin, a gas pipe is disposed between said carrier and said suspended object.

13. The apparatus of claim 6, further comprising an altitude sensor and an altitude controller being connected with said suspended object or said information transceiving device.

14. The apparatus of claim 13, further comprising a navigation and positioning device being connected with said suspended object or the information transceiving device.

15. The apparatus of claim 14, wherein said information transceiving device comprises a control rudder.

16. The apparatus of claim 1, wherein said carrier (4) is located on the ground or water surface.

17. The apparatus of claim 16, wherein said carrier (4) is a fixed carrier or a mobile carrier on the ground, or a carrier on water surface.
